(19) United States
(12) Patent Application Publication
(10) Pub. No.: US 2023/0381979 A1
(43) Pub. Date: Nov. 30, 2023

(54) MODULAR COMPLIANT INSERTS FOR BIOMIMETIC SKELETONS

(71) Applicant: Nicole KOHM, Larkspur, CO (US)

(72) Inventor: Nicole KOHM, Larkspur, CO (US)

(21) Appl. No.: 18/324,607

(22) Filed: May 26, 2023

Related U.S. Application Data
(60) Provisional application No. 63/346,292, filed on May 26, 2022.

(51) Int. Cl. B25J 17/02

(52) U.S. Cl. CPC B25J 17/0208

(57) ABSTRACT

Modular compliant inserts include interchangeable and fungible structural components for articulating movement in robotic, or biomechanic, skeletons and shells, such that each insert is devised as possessing a particular geometry, or specific degrees of freedom, that facilitates certain ranges of motion while inhibiting others thereby reproducing actions associated with various joints common to animals, such as hinge, pivot, ellipsoidal, and ball-and-socket joints. These modular compliant inserts are composed of lightweight polymeric material that accommodates the flexibility and durability required for their intended use while being readily producible through multiple manufacturing means. Devised to embody various shapes, depending on the location of use within the skeleton or shell, the modular compliant inserts are characterized by the presence of anchor members disposed at either end with a facile member therebetween, which connect with the ends of lever arms or other skeletal components joined together in a moveable array.

### BACKGROUND OF THE INVENTION

Various methods and mechanisms for mimicking biomechanical movements are known in the art. Many reproduce biomechanical movements by incorporating complex, articulated structures of rigid and load bearing components. What is needed is a plurality of modular compliant inserts for biomimetic skeletons and/or exoskeletons that are cost effective to produce, enable relative movement between load bearing levers, and are readily interchangeable and fungible in use with robotic skeletons.

### FIELD OF THE INVENTION

The present invention relates to a modular compliant inserts for biomimetic skeletons produced to be interchangeable and fungible in-use of robotic skeletons, exoskeletons, shells, and other structural components articulating movement in the robotic and biomechanical arts. Each of the modular compliant inserts has been devised with a particular geometry that facilitates movement in some ranges of motion while inhibiting other ranges of motion. Each modular insert has been devised to reproduce biomechanical action associated with the joints common to animals, including hinge joints, pivot joints, ellipsoidal joints, and ball and socket joints.

### SUMMARY OF THE INVENTION

The general purpose of the modular compliant inserts for biomimetic skeletons, described subsequently in greater detail, is to provide a system of modular compliant inserts for biomimetic skeletons which mimic motion of human and animal joints. The present modular compliant inserts for biomimetic skeletons have been devised to be mass producible and fungible. Each of the inserts comprises particular structure suited for use representing each of the joints associated with biomechanical motion whereby true and faithful degrees of freedom are represented in a realistic and efficient manner.

Each of the modular compliant inserts for biomimetic skeletons is devised of a polymer such as, for example, thermoplastic polyurethane, and have a hardness of approximately Shore A 90. Additional materials are contemplated as within scope of this invention that accommodate pliability, some elasticity, and durability, and that are relatively lightweight and readily producible by three-dimensional printing, molding, or other method of forming. Importantly, in some embodiments, it is contemplated that the modular compliant inserts for biomimetic skeleton may be printed in situ; that is, the printed or formed in position directly in between the lever arms or skeletal components they hingedly join.

The inserts comprise various shapes, devised to facilitate motion within specific degrees of freedom that represent the degrees of freedom associated with skeletal joints and structures. Each is characterized by anchoring members disposed at either end of a longitudinal axis. Anchoring members are devised to seat into ends of lever arms which are joined in moveable array be each of the said inserts. Anchoring members may also interconnect with lever arms or be attached or secured to lever arms in additional ways, such as by accommodating rods or fasteners therethrough or therein. A facile member is disposed between the anchor members. The facile members are devised to enable motion of the anchor members (and associated lever arms) relative to each other through at least one degree of freedom. Each facile member may include a diminished width or diameter at a medial portion thereof, said facile member thereby facilitating movement about the medial portion through at least one degree of freedom. In at least one example embodiment contemplated herein, a single anchor member is devised to position a facile member anteriorly thereupon for limited movement of lever arms and/or skeletal components jointed thereby. In other embodiments contemplated herein, anchor members may attach to, or accommodate, or encase, connect with, or otherwise securable operate in mechanical communication with structural components attached to ends or parts of lever arms which the inserts join. For example, an insert may be mounted interstitially between lever arms and maintained in position to effectuate relative motion of the lever arms by carbon rods, ligaments, pins, fasteners, or other attachments that secure the insert in position and enable articulated motion of the lever arms thereby.

For the purposes of this disclosure, the joints of an animal skeleton are generally fourfold and include hinge joints, pivot joints, ellipsoidal joints, and ball and socket joints. Hinge joints operate in a single degree of freedom, enabling extension and flexion of longitudinally disposed levers. Examples of hinge joints include human fingers and knees. Pivot joints enable rotational motion. An example of a pivot joint is the human neck. Ellipsoidal joints allow all types of movement except pivotal movement. An example of an ellipsoidal joint is the human wrist. Finally, ball and socket joints enable backward, forward, sideways, and rotating movements. Examples of ball and socket joints include the human hip and shoulder. Each of these joints is represented by a particular insert devised to represent and mimic the range of motion associated therewith. Some inserts may be usable to accommodate movement of more than one type of joint.

a. One Degree of Freedom Insert

A one degree of freedom (“1 DOF”) compliant insert is provided to biomimetically reproduce hinge joint movements. In an example embodiment herein provided, the 1 DOF compliant insert includes a generally hourglass or hyperboloid of one sheet shape or square-hyperboloid shape, having a facile member disposed as a medial narrows disposed between flared or widened anchor members. The medial narrows enables increased flexibility of the insert and the flared or widened anchor members enable seating engagement into suitable cavities disposed in ends of longitudinally related lever arms, which the instant insert joins together to enable relative motion therebetween. The square hyperboloid shape facilitates movement within one degree of freedom, enabling facility of extension and flexion within one plane of movement while resisting or inhibiting such movement in planes orthogonal thereto.

The 1 DOF compliant insert may be scaled to accommodate weight and force applied, such as weight and force required by the knee to support a body, for example, versus weight and force applied between the phalanxes of the fingers used for manipulating objects in the hands.

b. Three Degrees of Freedom Insert

A three degrees of freedom (“3 DOF”) insert is provided to biomimetically reproduce pivot joint movements and, in some embodiments, ellipsoidal joints.

The 3 DOF insert includes two trapezoidal anchor members disposed on either end of a cylindrical or hyperboloidal facile member. The radius of the facile member is substantially lesser than the width of each anchor member. The facile member may present a minimum radius at its center in exemplary hyperboloidal embodiments. The facile member enables movement of the anchor members relative to each other in forward, backward, and side-to-side motions, generally around a plane encircling the facile member, as well as accommodating some twisting movement whereby one anchor member is rotated relative to the other.

The 3 DOF insert is therefore usable for pivot joints, and may be usable to replicate movements in vertebrae, for example, the neck, or even in ellipsoidal joints such as wrists and ankles.

c. Conical Cup Insert

A conical cup insert is provided to biomimetically reproduce ball and socket joint movements in the form of a conical cup member and an anterior anchor member. In an example embodiment herein provided, the conical cup insert includes a conical cup member disposed with vertex integrated into a cylindrical or hyperboloidal facile member, which facile member terminates at an anterior anchor. The diameter of the facile member is substantially less than the diameter or width of the anterior anchor and substantially less than the diameter of the base of the conical cup member. The anterior anchor may be discoid or cuboid or another other shape. The cylindrical facile member is devised to enable rotational movements of the anterior anchor about a circle projected in parallel with the base of the conical cup member. The facile member may also accommodates some twisting motion.

The conical cup member, therefore, is disposed to attach to the end of a first lever arm. The conical cup member may attach via suction to smooth, obround, or spherical surfaces, or be adhered to the surface or otherwise fastened to the lever arm. The anterior anchor is disposed to seat into a cavity in a neighboring lever arm disposed at rest in a position disposed right-angularly relative to the first lever arm and in parallel with the base of the conical cup member. Movement is effectuated about the planar sections of the conical cup member, including forward, backward, upward, downward and rotational movements, effectuated by pliability of the facile member.

d. Shoulder Insert, Two Degree of Freedom Insert.

A shoulder insert, or two degree of freedom (“2 DOF”) insert, is also included herein, having two facile sections wherein the range of motion of a shoulder is duplicated. The 2 DOF insert operates through two degrees of freedom, pairing a portion moveable forwards and backwards with a portion that is moveable upwards and downwards. Collectively, these individual portions may mimic sufficient range of motion to duplicate movements of shoulders and/or other ball and socket and other joints.

In an example embodiment, the 2 DOF insert includes a first anchor member having a trapezoidal cross-section disposed to seat into a cavity disposed in a first lever arm. The first anchor member has an anterior surface disposed in parallel with its base that narrows into a first facile section. The first facile section may be parallelepiped in longitudinal and transverse cross sections and represents a relatively thin section that facilitates motion forwards and backwards in a plane parallel with the base of the first anchor member. The first facile section is adjoined to the first anchor member along one longitudinal side of the first facile section.

The first facile section adjoins a medial section disposed at the other longitudinal side of the first facile section. Thus movement of the first facile section is facilitated along its longitudinal axis and resisted along its transverse axis.

The medial section slopes angularly down relative to the anterior surface of the first anchor member to terminate at a second facile section that facilitates motion in a plane perpendicular to the range of motion facilitated by the first facile section. The second facile section is adjoined to the medial member along one longitudinal side that is disposed perpendicularly relative to the longitudinal sides of the first facile section. A second anchor member is disposed upon the other longitudinal side of the second facile section wherein motion is likewise facilitated about the longitudinal axis of the second facile section and inhibited about the transverse axis of the second facile section.

The combination of movements enabled at the first and second facile sections allows for at least two degrees of freedom and enables forwards, backwards, upwards and downwards movements relative to the first anchor member.

e. Limited Motion Insert

For joining some skeletal elements together while enabling limited range of motion, to allow flexion and extension of parts of a skeleton in response to other movements attributed across the skeleton, a limited motion insert is provided.

The limited motion insert is devised to be embedded between adjoining skeletal components wherein its range of motion is limited by its enclosure within the skeletal components while accommodating some motion at an anterior end thereof.

When seated therein, the anterior end of the limited motion insert is disposed to project a certain distance out of a cavity disposed in one component. The anterior end is then accommodated in a cavity disposed in an adjoining element. The elements are thereby joined to each other by the anterior end which accommodates some movement thereabouts.

An example embodiment here contemplated includes attachment of ribs to a vertebra, where limited motion of the rib relative to the vertebra is needed to mimic breathing, for example, and to accommodate flexion of the rib cage when the skeleton is moved in other capacities.

f. Supporting Interlinked Insert

In another example embodiment contemplated here, a range of motion is enabled by compliant inserts spaced apart upon and interlinked by spanning rods. In this example embodiment, each of the compliant inserts includes an anchor portion that is attached to the end of a lever arm or component of a skeleton or exoskeleton, as case may be, and the other anchor portion is impaled upon the end of an elongate rod that spans to another compliant insert likewise impaled by the elongate rod and anchored to another lever arm or skeletal component. A range of motion enabled by the respective facile members disposed between the anchor members of the compliant inserts therefore translates across the span of the rod. The compliant inserts may be arranged angularly relative to each other to thereby increase the range of motion along the rod in directions controlled by the spatial position and angle of the inserts in relation to each other.

Thus has been broadly outlined the more important features of the present modular compliant inserts for biomimetic skeletons so that the detailed description thereof that follows may be better understood and in order that the present contribution to the art may be better appreciated.

For better understanding of the modular compliant inserts for biomimetic skeletons, its operating advantages and specific objects attained by its uses, refer to the accompanying drawings and description.

### BRIEF DESCRIPTION OF THE DRAWINGS

### Figures

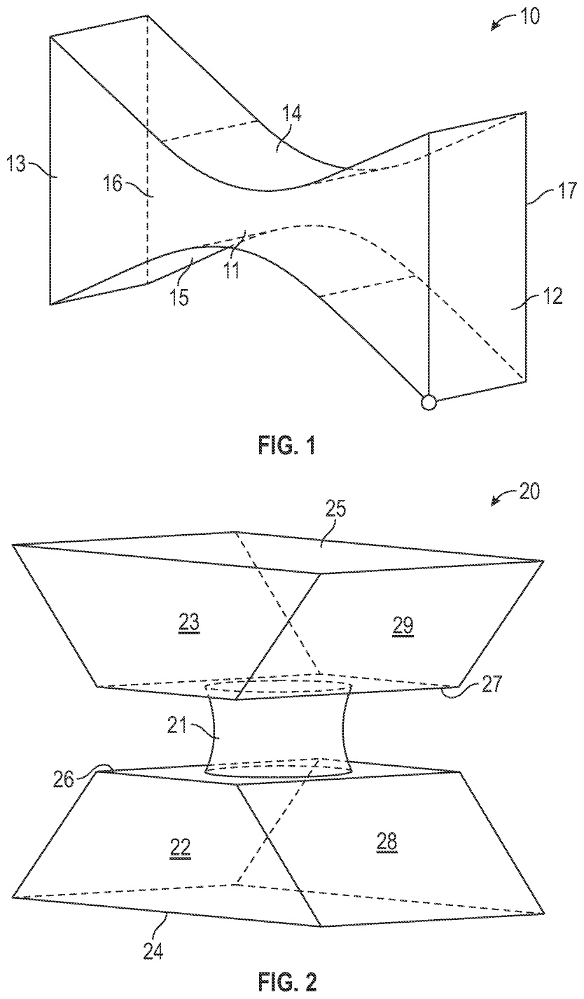

FIG. 1 is an elevation view of an example embodiment of a 1 DOF insert.

FIG. 2 is an elevation view of an example embodiment of a 3 DOF insert.

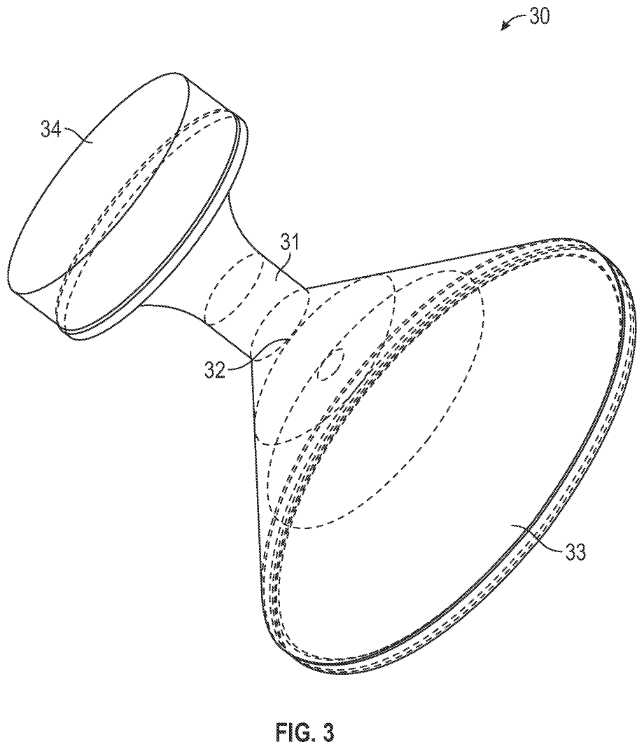

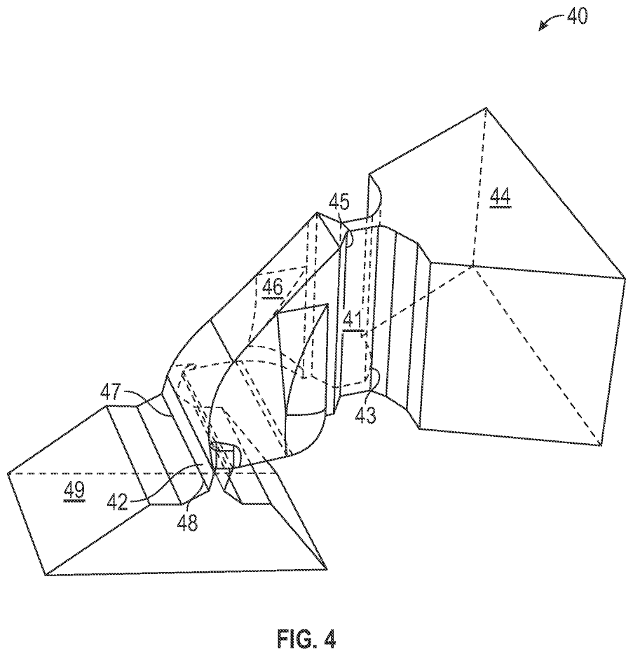

FIG. 3 is an elevation view of an example embodiment of a conical cup insert

FIG. 4 is an elevation view of an example embodiment of a 2 DOF insert.

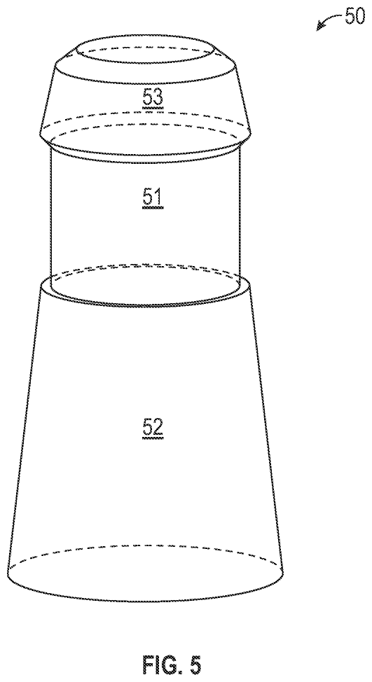

FIG. 5 is an elevation view of a limited motion insert.

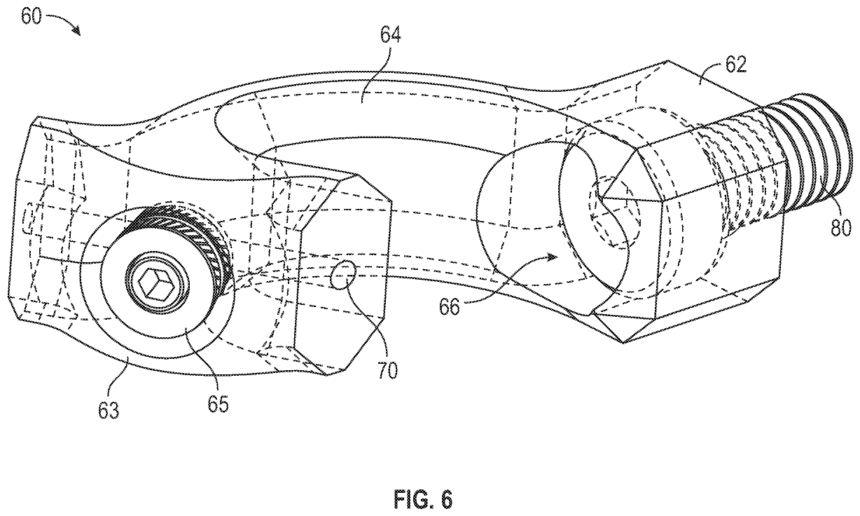

FIG. 6 is an elevation view of a supporting interlinked insert.

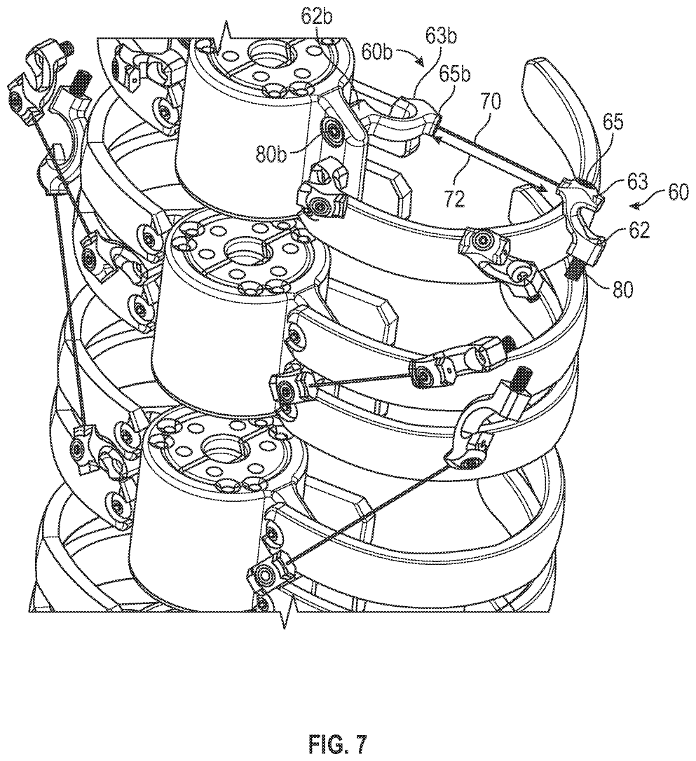

FIG. 7 is an elevation view of a plurality of interlinked inserts disposed upon a skeletal rib cage for articulation of movement of attached arms (not shown).

### DETAILED DESCRIPTION OF THE DRAWINGS

FIG. 1 illustrates an example embodiment of a 1 DOF insert 10. 1 DOF insert 10 is contemplated, in this example embodiment, to be rendered of thermoset polyurethane. Additional polymers and substances are contemplated for use as the 1 DOF insert 10, including silicones, rubbers, rubberlike materials, elastomeric materials, elasticized polymers, polymers, plastics, and other materials that are formable into the requisite shape, by three-dimensional printing, for example, molding, or forming, and which possess sufficient qualities and characteristics of flexibility, pliability and/or elasticity to enable controllable movement of two lever arms joined endwise together thereacross.

Facile member 11 is disposed as a medial narrows, having a minimal width and/or diameter midway between each of a pair of flared anchor members 12, 13. Flared anchor members insert into corresponding cavities or receptacles disposed upon associated lever arms which are joined together along a common longitudinal axis by 1 DOF insert 10. 1 DOF insert facilitates movement in one plane, wherein curved side 14 or side 15 compress and bend to enable movement within a sagittal plane relative thereto, and flat sides 16 and 17 inhibit movement in the plane that is coronal relative to sides 14 and 15. Thus facile member 11 facilitates movement through one degree of freedom. The 1 DOF insert 10 is usable for most hinge joints represented in animal anatomy and may be scaled to be larger, or thicker, to accommodate various load bearing capacities, such as when representing knees or elbows, say. It should be noted that the 1 DOF insert is easy to produce, at low cost, and is fungible between a variety of different hinge joints represented in a robotic skeleton.

FIG. 2 illustrates an example embodiment of a 3 DOF insert 20. Facile member 21 is shown between anchor members 22 and 23. The 3 DOF insert 20 is formed of a similar polymer or substance as set forth above for the 1 DOF insert 10.

In this example embodiment, facile member 21 is cylindrical or slightly hyperboloidal. Facile member 21 has a minimum diameter at a midpoint between anchor members 22 and 23. Facile member 21 facilitates movement in all directions in a plane transverse to the facile member 21. Thus anchor member 23 is moveable forwards, backwards, side to side, and diagonally relative to anchor member 22, and vice versa. Facile member 21 may also accommodate some twisting action.

In this example embodiment, anchor members 22 and 23 are generally trapezoidal, each having an enlarged base 24, 25 relative to a smaller apices 26, 27. The angled sides 28, 29 enable securement of the insert between ends of adjacent lever arms. Thus, the 3 DOF insert 20 may be useful for pivot, ellipsoidal, and, in some embodiment, ball and socket joints.

FIG. 3 illustrates an example embodiment of a conical cup insert 30. Conical cup insert 30 is made of like materials as set forth above, and includes facile member 31 disposed atop vertex 32 of conical cup 33. Conical cup 33 is devised to secure to a spherical or spheroidal surface or a lever arm and position anchor member 34 interior to cavity or receptacle disposed in adjacent lever arm. Anchor member 34 is therefore moveable in a circular manner around a transverse plane with respect to facile member 31, thereby replicating a range of motion similar to an animal ball and socket joint. As in facile member 21 of the 3 DOF insert 20 discussed above, some twisting action may be accommodated by facile member 31. Anchor member 34 may be discoid (as shown) or any other suitable shape that enables its general function.

FIG. 4 illustrates an example embodiment of a 2 DOF insert 40. 2 DOF insert 40 is made of like materials as discussed above. Shoulder member 40 is not limited to use replicating a shoulder, but rather simulates or replicates a range of motion common to ball and socket joints and may, therefore, be usable in addition to or in lieu of the conical cup insert 30 discussed above. 2 DOF insert 40 enables a progressed arrangement of lever arms between staggered or separated positions. 2 DOF insert includes two facile portions 41 and 42, each of which facilitate movement in directions that are forward and backward relative thereto. Facile portion 41 is disposed conjoined along longitudinal side 43 with anchor member 44, and longitudinal side 45 to medial portion 46. Facile portion 41 therefore facilitates movement of the medial portion relative anchor member 44 in a transverse plane relative to facile portion 41 while inhibiting movement in coronal or sagittal planes.

Medial portion 46 slopes downward and flares to merge with facile portion 42 conjoined along longitudinal side 47 therewith. Facile portion 42 is disposed with longitudinal sides 47, 48 at right angles to longitudinal sides 43, 45 and thereby enables movement of anchor member 49 in a transverse plane relative to the facile portion 42, which plane is coronal relative to facile portion 41. Thus movement in four directions is accommodated by the 2 DOF insert—movements forwards and backwards by facile member 41 and movements upwards and downwards by facile member 42. A range of motion approximately equivalent to the range of motion represented by a ball and socket joint, therefore, may be achieved.

FIG. 5 illustrates an example embodiment of a limited motion insert 50 devised to enable a limited range of motion between adjacently joined lever arms. Facile portion 51 is disposed atop frustoconical anchor member 52. Facile portion 51 is, in this example embodiment, cylindrical. Anchor member 53 is disposed atop facile portion 51. Limited motion insert 50 is devised to seat anchor member 52 into a cavity upon a first lever arm or structural component of a skeleton such that facile portion 51 is protruded therefrom to position anchor member 53 for engagement interior to a corresponding cavity or receptacle disposed in another lever arm or skeletal component. Motion within a plane transverse relative to facile portion 51 is constrained by the proximity of the adjoined skeletal components and by virtue of anchor member 52 comprising the majority of the insert 50. Such limited motion is useful to replicate, for example, the join of ribs to a vertebra, whereby some movement is accommodated at the costovertebral joints when breathing, for example, or in response to other bodily movements for which flexion of the costovertebral joints occurs.

Anchor member 53, due to its larger outer diameter relative to facile member 51, may further serve as a barb or a one-way fastening element between lever arms of skeletal components, wherein anchor member 53 pierces through or into an aperture in one direction, to seat facile portion 51 in position, while resisting or preventing separation in the other direction.

FIG. 6 is an elevation view of a supporting interlinked insert 60, devised for use with another such insert 60b disposed endwise upon elongate rod or fiber 70. In this example embodiment, the interlinked insert 60 is generally C-shaped, having a pair of anchors 62, 63 disposed endwise upon an arcuate span 64. Interlinked insert 60 may be other than C-shaped; such as, for example, elongate, cylindrical, obround, or other shape suited to absorb shocks, pressures, and bend in desired directions in response to applied forces. Anchor 62 includes a seat 66 for fastener 80, by which the insert 60 is secured to a skeletal component or lever arm (see, e.g., FIG. 7). Anchor 63 includes clamp member 65, devised to securely fasten rod or fiber 70 member in position impaling anchor 63. Clamp member 65 may be heat-set and comprise threaded portions to rotationally engage and adjustably secure rod or fiber 70 and thereby modulate tension across span 72.

As shown in FIG. 7, rod or fiber 70 spans to another insert 60b, disposed endwise upon rod or fiber 70 which spans length 72. Anchor 62b is secured to another skeletal component in like manner as described above, by action of fastener 80b. A range of motion is therefore translated along length 72 of rod or fiber 80, and compliant inserts 60, 60b enable movement by flexing each respective arcuate span 64, 64b.

What is claimed is:

1. A modular compliant insert for biomimetic skeletons comprising:
a first anchor member disposed for securement to a portion of a biomimetic skeleton;
a second anchor member disposed for securement to another portion of the biomimetic skeleton separate from the portion to which the first anchor member is secured; and
a facile member disposed between, and conjoined to, the first anchor member and the second anchor member, said facile member configured to facilitate motion of the first anchor member and second anchor member relative to each other through at least one degree of freedom;
wherein articulated portions of the biomimetic skeleton secured to the anchor members may simulate the motion of hinge joints, pivot joints, ellipsoidal joints, ball and socket joints, or other motions requiring at least one degree of freedom between articulated portions of the biomimetic skeleton.

2. The modular compliant insert of claim 1 wherein the anchor members and facile member are devised of an elastomeric polymer that is lightweight and durable, such as such as the thermoplastic polyurethane.

3. The modular compliant insert of claim 1 wherein the facile member is created, molded, shaped, or otherwise formed to be cylindrical.

4. The modular compliant insert of claim 1 wherein the medial member is created, molded, shaped, or otherwise formed to be hyperboloidal or an extruded plane section thereof, [whereby it may inhibit at least one degree of freedom].

5. The modular compliant insert of claim 1 wherein the facile member is created, molded, shaped, or otherwise formed to be partially cylindrical and partially hyperboloidal.

6. The modular compliant insert of claim 3 wherein the first anchor member is created, molded, shaped, or otherwise formed to resemble a frustoconical prism.

7. The modular compliant insert of claim 9 wherein the second anchor member is created, molded, shaped, or otherwise formed to resemble a cylindrical hemisphere.

8. The modular compliant insert of claim 4 wherein the first and second anchor members are created, molded, shaped, or otherwise formed to resemble trapezoidal prisms.

9. The modular compliant insert of claim 5 wherein the first anchor member is created, molded, shaped, or otherwise formed to resemble a frustoconical prism having an overextended edge [flange].

10. The modular compliant insert of claim 9 wherein the second anchor member is created, molded, shaped, or otherwise formed to resemble a discoid, cuboid, or another three-dimensional shape.

11. A modular compliant insert for biomimetic skeletons comprising:
a first anchor member disposed for securement to a portion of a biomimetic skeleton;
a bendable protrusion extending from the first anchor member;
a second anchor member disposed for securement to another portion of the biomimetic skeleton separate from the portion to which the first anchor member is secured;
a bendable protrusion extending from the second anchor member; and
a facile member disposed between, and conjoined to, the bendable protrusions of both the first anchor member and the second anchor member, said facile member configured to facilitate motion of the first anchor member and second anchor member relative to each other through at least one degree of freedom;
wherein the first anchor's bendable protrusion is perpendicularly oriented relative to the second anchor's bendable protrusion.

12. The modular compliant insert of claim 11 wherein the anchor members, their bendable protrusions, and the facile member are devised of an elastomeric polymer that is lightweight and durable, such as such as the thermoplastic polyurethane.

13. The modular compliant insert of claim 11 wherein the first and second anchor members are created, molded, shaped, or otherwise formed to resemble trapezoidal prisms.

14. The modular compliant insert of claim 13 wherein the bendable protrusions [of the first and second anchor members] are created, molded, shaped, or other otherwise formed to resemble an extruded bowtie, or I-beam, whereby the baseline thereof is parallel to its anchor member's base and the extrusion spans the distance between the trapezoidal faces of its anchor member.

15. A modular compliant insert for biomimetic skeletons comprising:
a first anchor member having a fastening, or securement, seat;
a second anchor member having a cylindrical void extruded through it and
a clamp member rotationally engaging along its length perpendicular thereto; and
a facile portion disposed between, and conjoined to, the first anchor member and the second anchor member;

16. The modular compliant insert of claim 15 wherein the anchor and facile portions are devised of an elastomeric polymer that is lightweight and durable, such as such as the thermoplastic polyurethane.

17. The modular compliant insert of claim 15 wherein the anchor and facile portions may be C-shaped, elongated, cylindrical, obround, or otherwise shaped in a manner suitable to absorbing shocks, pressures, and applied forces through bending, rotating, or otherwise maneuvering only in designed degrees of freedom.

18. The modular compliant insert of claim 15 wherein the second anchor portion's cylindrical void may be occupied by rods or fibers connected to other modular compliant inserts in like manner.

19. The modular compliant insert of claim 18 wherein the second anchor portion's clamping member may be rotated to engage and adjustably secure the impaling rod or fiber in place.

20. The modular compliant insert of claim 15 wherein the first anchor portion's fastening, or securement, seat is occupied by a threaded fastener capable of fastening or securement to a biomimetic skeleton component or lever arm.
